(19) United States
(12) Patent Application Publication
(10) Pub. No.: US 2007/0132221 A1
(43) Pub. Date: Jun. 14, 2007

(54) ENERGY ABSORBING FILL TUBE FOR A SIDE CAR CURTAIN SYSTEM

(75) Inventor: Brian J. Reynolds, Oxford, MI (US)

Correspondence Address: ARTZ & ARTZ, P.C., 28333 TELEGRAPH ROAD, SUITE 250, SOUTHFIELD, MI, 48034, US

(73) Assignee: LEAR CORPORATION, Southfield, MI (US)

(21) Appl. No.: 11/164,989

(22) Filed: Dec. 13, 2005

(51) Int. Cl. B60R 21/26; B60R 21/213

(52) U.S. Cl. 280/740; 280/730.2; 280/742

(57) ABSTRACT

An energy-absorbing fill tube for a side air curtain system for a vehicle. The fill tube is a hollow tube having a longitudinal axis and a series of waistband wrinkles along the longitudinal axis. The hollow tube is integrated within the vehicle and defines a conduit for directing air into an air curtain for the side air curtain system. The waistband wrinkles deforms under a predetermined load and is sufficiently rigid for maintaining the conduit and directing air into the air curtain under the predetermined load.

### TECHNICAL FIELD

The present invention relates generally to vehicles, and more particularly to an energy-absorbing fill tube for a side air curtain system for a vehicle.

### BACKGROUND OF THE INVENTION

Side air curtain systems for vehicles substantially enhance passenger safety in side-impact collisions and vehicle roll-overs. The typical side air curtain system includes a crash sensor, an inflation mechanism, an air curtain, and a rigid non-deformable fill tube in connection between the inflation mechanism and the air curtain. The fill tube typically is sufficiently rigid that it remains generally undeformed in a side impact collision. This strong construction is beneficial for maintaining a conduit for directing air from the inflation mechanism to the air curtain. However, it will be appreciated that the rigid non-deformable fill tube does not absorb crash energy in a collision.

Existing vehicles have a roof rail structure with a side air curtain system and a countermeasure therein. The countermeasure absorbs crash energy in a side impact collision, e.g. with an occupant's head or torso impacted thereon. The typical countermeasure has a generally small mass comprised of a foam, paper, metal composite, or plastic material. However, it is understood that countermeasure nonetheless provides additional weight to the vehicle and thus diminishes the fuel economy and overall performance. Also, installation of the countermeasure can increase the manufacturing cycle time for the vehicle, as well as the costs associated therewith.

It would therefore be desirable to provide a fill tube for a side air curtain system for a vehicle that quickly deploys an air curtain in a vehicle collision and also absorbs crash energy.

### SUMMARY OF THE INVENTION

One advantageous embodiment of the claimed invention is an energy-absorbing fill tube for a side air curtain system for a vehicle. The fill tube is a hollow tube having a longitudinal axis and a series of waistband wrinkles along the longitudinal axis. The hollow tube is integrated within the vehicle and defines a conduit for directing air into an air curtain for the side air curtain system. The waistband wrinkles deforms under a predetermined load and is sufficiently rigid for maintaining the conduit and directing air into the air curtain under the predetermined load.

One advantage of the present invention is that an energy-absorbing fill tube is provided that absorbs crash energy in a vehicle collision and thus improves passenger safety.

Another advantage of the present invention is that an energy-absorbing fill tube is provided that quickly deploys a side air curtain and assists in providing peak pressure and steady-state pressure valves for cushioning a passenger in a vehicle collision.

Yet another advantage of the present invention is that an energy-absorbing fill tube is provided that can eliminate the need for countermeasures in a vehicle and therefore decrease vehicle weight, enhance fuel economy and otherwise improve overall vehicle performance.

Still another advantage of the present invention is that an energy-absorbing fill tube is provided that decreases the overall weight and minimizes the cost of manufacturing the vehicle.

Other advantages of the present invention will become apparent when viewed in light of the detailed description of the invention in conjunction with the attached drawings and appended claims.

### BRIEF DESCRIPTION OF THE DRAWINGS

For a more complete understanding of this invention, reference should now be made to the embodiments illustrated in greater detail in the accompanying drawings and described below by way of examples of the invention:

FIG. 1 is a perspective cutaway view of a vehicle having a side air curtain system with an energy-absorbing fill tube, according to one advantageous embodiment of the claimed invention; and

FIG. 2 is an enlarged view of the energy-absorbing fill tube shown in FIG. 1 and encircled within circle 2.

### DETAILED DESCRIPTION OF THE INVENTION

In the following figures, the same reference numerals are used to identify the same components in the various views. Furthermore, the illustrated embodiments described herein employ features where the context permits. Specifically, the embodiments described herein implement an energy-absorbing fill tube for a side air curtain system for a vehicle. However, it is contemplated that the fill tube can instead be utilized for a variety of other suitable systems and/or in stationary structures as desired. In this regard, other embodiments are contemplated lacking one or more of the described features, having features other than those described herein, or having different combinations of those features. It is therefore appreciated that the invention can be carried out in a variety of suitable modes.

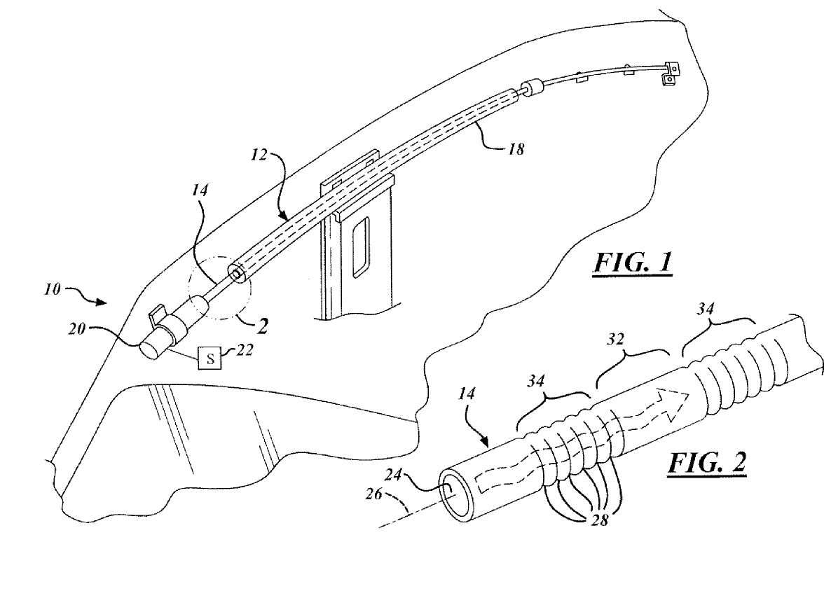

Referring to FIG. 1, there is shown a vehicle 10 having a side air curtain system 12 with an energy-absorbing fill tube 14, according to one advantageous embodiment of the claimed invention. In this embodiment, the vehicle 10 has a roof structure 16 with the side air curtain system 12 therein. The side air curtain system 12 is comprised of an air curtain 18, the energy-absorbing fill tube 14 (“fill tube”), an inflator device 20, and one or more crash sensors 22. The crash sensor 22 is an electromechanical accelerometer that actuates the inflator device 20 to inject a blast of air through the fill tube 14 and into the air curtain 18. It is contemplated that the crash sensor 22 can instead be a mechanical accelerometer or other suitable sensor as desired. Also, in this embodiment, the inflator device 20 includes a sodium azide propellant for producing the blast of air and inflating the air curtain 18. However, it is understood that other suitable inflator devices and inflatable airbags can be utilized as desired.

With attention now to FIG. 2, the fill tube 14 is a hollow tube defining a conduit 24 in open communication between the inflator device 20 and the air curtain 18. The fill tube 14 is sufficiently rigid for maintaining the conduit 24 under a predetermined load, e.g. a crash load, and directing air from the inflator device 20 into the air curtain 18. In this embodiment, the fill tube 14 is comprised of substantially strong and light aluminum construction. It will be appreciated that the hollow tube can instead be comprised of other metals, alloys thereof, or other suitable materials.

The fill tube 14 has a longitudinal axis 26 and a series of waistband wrinkles 28 along the longitudinal axis 26 that are sufficiently deformable for absorbing crash energy. The waistband wrinkles 28 are also sufficiently rigid for maintaining the conduit 24 and directing air into the air curtain 18 under a predetermined load. Accordingly, the fill tube 14 sufficiently passes air therethrough and deploys the air curtain 18 while also absorbing crash energy in a vehicle collision. The waistband wrinkles 28 are beneficial for enhancing passenger safety and eliminating the need for countermeasures within the roof structure 16. However, it is contemplated that the roof structure 16 can have one or more countermeasures 30 therein as desired.

In particular, in this embodiment, the fill tube 14 has at least one portion 32 with a constant diameter and each waistband wrinkle 28 comprising a decreased diameter portion of the fill tube 14, along a substantially short length of the fill tube 14. Accordingly, each waistband wrinkle 28 provides a stress riser in the fill tube 14. Also, in this embodiment, the fill tube 14 has at least two clusters 34 of adjacent waistband wrinkles 28 along the longitudinal axis 26 of the tube 14. It will be appreciated that the fill tube 14 can instead have only one cluster of waistband wrinkles 28 that are spaced apart an equal distance or otherwise as desired.

While particular embodiments of the invention have been shown and described, numerous variations and alternate embodiments will occur to those skilled in the art. Accordingly, it is intended that the invention be limited only in terms of the appended claims.

What is claimed is:

1. An energy-absorbing fill tube for a side air curtain system for a vehicle, comprising:
a hollow tube having a longitudinal axis and a series of waistband wrinkles along said longitudinal axis;
said hollow tube integrated within said vehicle and defining a conduit for directing into an air curtain for said side air curtain system;
said series of waistband wrinkles deforming under a predetermined load;
said series of waistband wrinkles sufficiently rigid for maintaining said conduit and directing air into said side air curtain under said predetermined load.

2. The energy-absorbing fill tube recited in claim 1 wherein said hollow tube is comprised of a metal.

3. The energy-absorbing fill tube recited in claim 2 wherein said metal is aluminum.

4. The energy-absorbing fill tube recited in claim 1 wherein said series of waistband wrinkles is comprised of at least one cluster of adjacent waistband wrinkles in said hollow tube.

5. The energy-absorbing fill tube recited in claim 1 wherein said series of waistband wrinkles is comprised of said hollow tube having a nonuniform diameter along said longitudinal axis.

6. The energy-absorbing fill tube recited in claim 1 wherein said series of waistband wrinkles is comprised of said hollow tube having a plurality of diameters along said longitudinal axis.

7. A side air curtain system for a vehicle comprising:
said hollow tube recited in claim 1;
an air curtain; and
an inflator device inflating said air curtain by said hollow tube.

8. A side air curtain system for a vehicle comprising:
an air curtain;
a hollow tube having a longitudinal axis and a series of waistband wrinkles along said longitudinal axis;
said hollow tube integrated within said vehicle and defining a conduit for directing air into said air curtain;
said series of waistband wrinkles deforming under a predetermined load;
said series of waistband wrinkles sufficiently rigid for maintaining said conduit and directing air into said side air curtain under said predetermined load;
an inflator device inflating said air curtain by said hollow tube; and
at least one crash sensor actuating said inflator device.

9. The side air curtain system recited in claim 8 wherein said hollow tube is comprised of a metal.

10. The side air curtain system recited in claim 9 wherein said metal is aluminum.

11. The side air curtain system recited in claim 8 wherein said series of waistband wrinkles is comprised of at least one cluster of adjacent waistband wrinkles in said hollow tube.

12. The side air curtain system recited in claim 8 wherein said series of waistband wrinkles is comprised of said hollow tube having a nonuniform diameter along said longitudinal axis.

13. The side air curtain system recited in claim 8 wherein said series of waistband wrinkles is comprised of said hollow tube having a plurality of diameters along said longitudinal axis.

14. The side air curtain system recited in claim 8 wherein said at least one crash sensor is selected from the group consisting of a mechanical accelerometer and an electromechanical accelerometer.

15. The side air curtain system recited in claim 8 wherein said inflator device is comprised of a sodium azide propellant.

16. A vehicle comprising:
a roof rail structure;
an air curtain within said roof rail structure;
an inflator device inflating said air curtain;
at least one crash sensor actuating said inflator device; and
a hollow tube within said roof rail structure;
said hollow tube having a longitudinal axis and a series of waistband wrinkles along said longitudinal axis;
said hollow tube defining a conduit for directing air from said inflator into said air curtain;
said series of waistband wrinkles deforming under a predetermined load;
said series of waistband wrinkles sufficiently rigid for maintaining said conduit and directing air into said side air curtain under said predetermined load.

17. The side air curtain system recited in claim 16 wherein said hollow tube is comprised of a metal.

18. The side air curtain system recited in claim 17 wherein said metal is aluminum.

19. The side air curtain system recited in claim 16 wherein said series of waistband wrinkles is comprised of at least one cluster of adjacent waistband wrinkles in said hollow tube.

20. The side air curtain system recited in claim 16 wherein said series of waistband wrinkles is comprised of said hollow tube having a plurality of diameters along said longitudinal axis.
